(19) United States
(12) Patent Application Publication
(10) Pub. No.: US 2026/0177772 A1
(43) Pub. Date: Jun. 25, 2026

(54) METHOD FOR MANUFACTURING OPTICAL FIBER

(71) Applicant: SUMITOMO ELECTRIC INDUSTRIES, LTD., Osaka-shi, Osaka (JP)

(72) Inventors: Yudai WATANABE, Osaka-shi, Osaka (JP); Kazuyuki SOHMA, Osaka-shi, Osaka (JP)

(21) Appl. No.: 18/834,368

(22) PCT Filed: Jun. 24, 2024
(86) PCT No.: PCT/JP2024/022803

§ 371 Date: Jul. 30, 2024

(30) Foreign Application Priority Data
Aug. 21, 2023 (JP) 2023-133925

(51) Int. Cl. G02B 6/44; C03C 25/104; C03C 25/6226; G02B 6/02

(52) U.S. Cl. CPC G02B 6/4479; C03C 25/104; C03C 25/6226; G02B 6/02395; C03C 2218/32

(57) ABSTRACT

According to the present disclosure, provided is a method for manufacturing an optical fiber from a glass fiber obtained by heating and drawing an optical fiber preform, the method including: an application step of applying an ultraviolet-curable resin to the glass fiber; and a curing step of irradiating the ultraviolet-curable resin with ultraviolet light to cure the ultraviolet-curable resin. The curing step includes: a first irradiation step of irradiating the ultraviolet-curable resin with ultraviolet light from an ultraviolet LED as a light source; and a second irradiation step of irradiating the ultraviolet-curable resin with ultraviolet light from an ultraviolet lamp as a light source in this order. A surface temperature of the ultraviolet-curable resin at start of the second irradiation step is 300° C. or lower.

### TECHNICAL FIELD

The present disclosure relates to a method for manufacturing an optical fiber. The present application claims priority based on Japanese Patent Application No. 2023-133925 filed on Aug. 21, 2023, the entire content of which is incorporated herein by reference.

### BACKGROUND ART

Patent Literature 1 discloses a method for manufacturing an optical fiber in which a resin composition applied to a glass fiber is cured by being irradiated with ultraviolet light components having different wavelengths in binary steps.

### CITATION LIST

### Patent Literature

Patent Literature 1: JP2018-177630A

### SUMMARY OF INVENTION

A method for manufacturing an optical fiber according to one embodiment of the present disclosure is a method for manufacturing an optical fiber from a glass fiber obtained by heating and drawing an optical fiber preform, the method including: an application step of applying an ultraviolet-curable resin to the glass fiber; and a curing step of irradiating the ultraviolet-curable resin with ultraviolet light to cure the ultraviolet-curable resin, in which the curing step includes a first irradiation step of irradiating the ultraviolet-curable resin with ultraviolet light from an ultraviolet LED as a light source and a second irradiation step of irradiating the ultraviolet-curable resin with ultraviolet light from an ultraviolet lamp as a light source in this order, and a surface temperature of the ultraviolet-curable resin at start of the second irradiation step is 300° C. or lower.

### BRIEF DESCRIPTION OF DRAWINGS

FIG. 1 is a cross-sectional view illustrating an example of a configuration of an optical fiber.

FIG. 2 is a schematic diagram illustrating an example of a device for executing a method for manufacturing an optical fiber according to one embodiment of the present disclosure.

### DESCRIPTION OF EMBODIMENTS

### Technical Problem

In manufacturing steps of an optical fiber, a coating layer is formed by covering a drawn glass fiber with an ultraviolet-curable resin and irradiating and curing the resin with ultraviolet light. In the related art, an ultraviolet lamp has been used as a light source of ultraviolet light. Recently, however, use of an LED has been considered (for example, Patent Literature 1). When the LED is used as the light source of ultraviolet light for curing the ultraviolet-curable resin, transmission loss of a manufactured optical fiber at a low temperature may increase. An object of the present disclosure is to improve low-temperature characteristics of a manufactured optical fiber when an LED is used as a light source of ultraviolet light for curing an ultraviolet-curable resin during manufacturing of an optical fiber.

### Advantageous Effects of Invention

With the method for manufacturing an optical fiber according to the present disclosure, low-temperature characteristics of a manufactured optical fiber can be improved when an ultraviolet LED is used as a light source of ultraviolet light for curing an ultraviolet-curable resin during manufacturing of an optical fiber.

### DESCRIPTION OF EMBODIMENT OF PRESENT DISCLOSURE

First, an embodiment of the present disclosure will be described.
(1) A method for manufacturing an optical fiber according to one embodiment of the present disclosure is
a method for manufacturing an optical fiber from a glass fiber obtained by heating and drawing an optical fiber preform, the method including: an application step of applying an ultraviolet-curable resin to the glass fiber; and a curing step of irradiating the ultraviolet-curable resin with ultraviolet light to cure the ultraviolet-curable resin, in which the curing step includes a first irradiation step of irradiating the ultraviolet-curable resin with ultraviolet light from an ultraviolet LED as a light source and a second irradiation step of irradiating the ultraviolet-curable resin with ultraviolet light from an ultraviolet lamp as a light source in this order, and a surface temperature of the ultraviolet-curable resin at start of the second irradiation step is 300° C. or lower.

With the above-described configuration, low-temperature characteristics of a manufactured optical fiber can be improved. More specifically, transmission loss at a low temperature can be reduced.
(2) In the method for manufacturing an optical fiber according to (1), the second irradiation step may be executed continuously after the first irradiation step.

With the above-described configuration, productivity is improved by collectively executing the curing step.
(3) In the method for manufacturing an optical fiber according to (2), a period of time from end of the first irradiation step to the start of the second irradiation step may be 0.075 seconds or shorter.

With the above-described configuration, productivity is further improved.
(4) In the method for manufacturing an optical fiber according to any one of (1) to (3), an oxygen concentration in an outlet of an ultraviolet irradiation reactor used in the first irradiation step may be 0.3 vol % or less, and an oxygen concentration in an outlet of an ultraviolet irradiation reactor used in the second irradiation step may be 0.6 vol % or less.

With the above-described configuration, the external appearance of an optical fiber is excellent.

### Details of Embodiment of Present Disclosure

A specific example of a method for manufacturing an optical fiber according to the present disclosure will be described below with reference to the drawings. The present invention is not limited to these examples and is intended to include any modifications in the scope and meaning equivalent to the terms of the claims.

### Optical Fiber

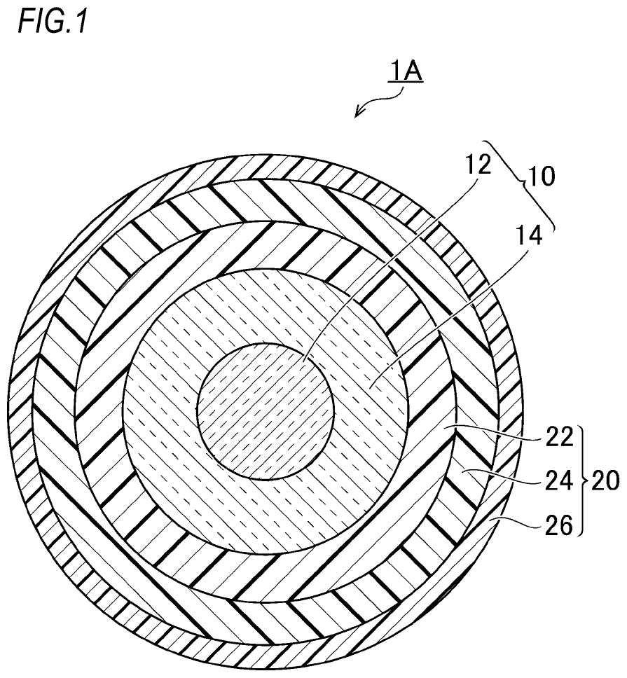

First, an example of an optical fiber manufactured using the method for manufacturing an optical fiber according to the present embodiment will be described. FIG. 1 is a cross-sectional view illustrating a configuration of an optical fiber 1A, in which a cross-section perpendicular to a central axis (optical axis) of an optical fiber 1A is illustrated. As illustrated in FIG. 1, the optical fiber 1A includes a glass fiber 10 that is an optical transmission member and a coating resin film 20. The glass fiber 10 includes a core 12 and a cladding 14 that covers the core 12. The coating resin film 20 is an ultraviolet-curable film that covers the cladding 14. The coating resin film 20 includes a plurality of layers. The coating resin film 20 includes, for example, a primary resin layer 22, a secondary resin layer 24, and a colored resin layer 26. At least the primary resin layer 22 and the secondary resin layer 24 among the plurality of coating a resin films 20 are obtained by curing an ultraviolet-curable resin including photopolymerization initiator.

The glass fiber 10 is a member formed of glass and is formed of, for example, silica (SiO₂) glass. The glass fiber 10 transmits light introduced into the optical fiber 1A. The core 12 is provided, for example, in a region including a central axis line of the glass fiber 10. The core 12 is pure SiO₂ glass. Alternatively, the SiO₂ glass may include GeO₂ and/or fluorine or the like. The cladding 14 is provided in a region surrounding the core 12. The cladding 14 has a lower refractive index than the core 12. The cladding 14 may be formed of pure SiO₂ glass or may be formed of SiO₂ glass to which fluorine is added.

The primary resin layer 22 is in contact with an outer peripheral surface of the cladding 14 and covers the entirety of the cladding 14. The secondary resin layer 24 is in contact with an outer peripheral surface of the primary resin layer 22 and covers the entirety of the primary resin layer 22. The colored resin layer 26 is in contact with an outer peripheral surface of the secondary resin layer 24 and covers the entirety of the secondary resin layer 24. For example, the thickness of the primary resin layer 22 may be 20 μm or more and 50 μm or less, the thickness of the secondary resin layer 24 may be 10 μm or more and 40 μm or less, and the thickness of the colored resin layer 26 may be 3 μm or more and 10 μm or less. The secondary resin layer 24 can also function as the colored layer such that the colored resin layer 26 provided outside the secondary resin layer 24 can be removed. The Young's modulus of the primary resin layer 22 can be 0.5 MPa or less and may be 0.3 MPa or less.

The primary resin layer 22 and the secondary resin layer 24 are formed, for example, by curing an oligomer, a monomer, and an ultraviolet-curable resin including a photopolymerization initiator (reaction initiator).

As the oligomer, urethane acrylate, epoxy acrylate, or a mixed system thereof can be used. As the urethane acrylate, a reaction product obtained by reaction of a polyol compound, a polyisocyanate compound, and a hydroxyl group-containing acrylate compound can be used.

As the polyol compound, polytetramethylene glycol, polypropylene glycol, bisphenol A-ethylene oxide adduct diol, or the like can be used. As the polyisocyanate compound, 2,4-tolylene diisocyanate, 2,6-tolylene diisocyanate, isophorone diisocyanate, or the like can be used. As the hydroxyl group-containing acrylate compound, 2-hydroxyethyl acrylate, 2-hydroxybutyl acrylate, 1,6-hexanediol monoacrylate, pentaerythritol triacrylate, 2-hydroxypropyl acrylate, tripropylene glycol diacrylate, or the like can be used.

The monomer is a N-vinyl monomer having a ring structure. For example, N-vinylpyrrolidone, N-vinyl caprolactone, or acryloylmorpholine can be used. When the monomer is provided, the curing rate is improved, which is preferable. As monomers other than the above-described monomers, a monofunctional monomer such as isobornyl acrylate, tricyclodecanyl acrylate, benzyl acrylate, dicyclopentanyl acrylate, 2-hydroxyethyl acrylate, nonylphenyl acrylate, phenoxyethyl acrylate, or polypropylene glycol monoacrylate; or a polyfunctional monomer such as polyethylene glycol diacrylate, tricyclodecane diyl dimethylene diacrylate, or bisphenol A-ethylene oxide adduct diol diacrylate is used. The above-described acrylate compound may be a methacrylate compound corresponding to the each of the monomers.

Examples of the photopolymerization initiator include an acylphosphine oxide-based initiator and an acetophenone-based initiator. Examples of the acylphosphine oxide-based initiator include an acylphosphine oxide-based compound such as 2,4,6-trimethylbenzoyl diphenylphosphine oxide (registered trade name; LUCIRIN TPO, manufactured by BASF SE), 2,4,4-trimethylpentyl phosphine oxide, or 2,4,4-trimethylbenzoyl diphenylphosphine oxide. The acylphosphine oxide-based initiator has a wide absorption wavelength range, has absorption in a visible range, and has excellent deep-part curability. Therefore, the acylphosphine oxide-based initiator can be used for the primary resin layer 22 and the secondary resin layer 24.

Examples of the acetophenone-based initiator include an acetophenone-based compound such as 1-hydroxycyclohexan-1-yl phenyl ketone (registered trade name: IRGACURE 184, manufactured by BASF SE), 2-hydroxy-2-methyl-1-phenyl-propan-1-one (registered trade name: DAROCUR 1173, manufactured by BASF SE), 2,2-dimethoxy-1,2-diphenylethan-1-one (registered trade name: IRGACURE 651, manufactured by BASF SE), 2-methyl-1-(4-methylthiophenyl)-2-morpholinopropan-1-one (registered trade name: IRGACURE 907, manufactured by BASF SE), 2-benzyl-2-dimethylamino-1-(4-morpholinophenyl)-butanone-1 (registered trade name: IRGACURE 369, manufactured by BASF SE), 1-hydroxycyclohexyl phenyl ketone, 2,2-dimethoxy-2-phenylacetophenone, or 1-(4-isopropylphenyl)-2-hydroxy-2-methylpropan-1-one. The acetophenone-based initiator is not likely to be affected by oxygen inhibition, and thus is used for, for example, the secondary resin layer 24 in combination with, for example, the acylphosphine oxide-based initiator such as LUCIRIN TPO having excellent deep-part curability.

### Method For Manufacturing Optical Fiber

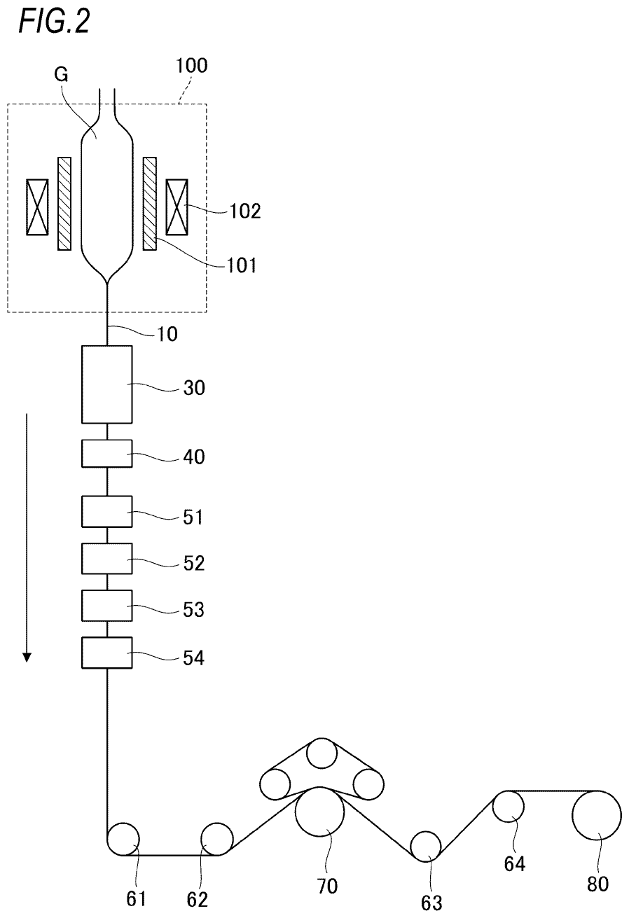

FIG. 2 is a schematic diagram illustrating an example of a manufacturing device for executing a method for manufacturing an optical fiber according to one embodiment of the present disclosure. Hereinafter, the method for manufacturing an optical fiber according to the present embodiment will be described with reference to FIG. 2.

A heating furnace 100 is a device for heating an optical fiber preform G. The heating furnace 100 includes a furnace tube 101 and a heater 102. The glass fiber 10 is obtained by drawing the optical fiber preform G heated by the heating furnace 100. The glass fiber 10 obtained by heating and drawing the optical fiber preform G travels in a direction indicated by an arrow in FIG. 2 and is provided for each of steps described below.

The drawn glass fiber 10 is cooled by a cooling device 30 first. The cooled glass fiber 10 is subsequently transmitted to an application device 40, and an ultraviolet-curable resin is applied to a surface of the glass fiber 10 (application step). More specifically, a first ultraviolet-curable resin is applied to the surface of the glass fiber 10 to form a first layer including the first ultraviolet-curable resin on the surface of the glass fiber 10, and a second ultraviolet-curable resin is applied to a surface of the first layer to form a second layer including the second ultraviolet-curable resin on the surface of the first layer. The first layer is a layer corresponding to the cured primary resin layer 22, and the second layer is a layer corresponding to the cured secondary resin layer 24. Each of the first ultraviolet-curable resin and the second ultraviolet-curable resin may include the oligomer, the monomer, and the photopolymerization initiator. The first ultraviolet-curable resin may include, for example, the acylphosphine oxide-based initiator as the photopolymerization initiator. The second ultraviolet-curable resin may include, for example, the acylphosphine oxide-based initiator and the acetophenone-based initiator as the photopolymerization initiator. In the following description, the glass fiber 10 having the surface to which the ultraviolet-curable resin is applied will also be simply referred to as “glass fiber 10”.

Next, the glass fiber 10 is irradiated with ultraviolet light to cure the ultraviolet-curable resin applied to the surface (curing step). In the configuration illustrated in FIG. 2, the curing step is executed by a first ultraviolet irradiation reactor 51, a second ultraviolet irradiation reactor 52, a third ultraviolet irradiation reactor 53, and a fourth ultraviolet irradiation reactor 54. The curing step in the method for manufacturing an optical fiber according to the present embodiment includes a first irradiation step of irradiating the ultraviolet-curable resin with ultraviolet light from an ultraviolet LED (Light Emitting Diode) as a light source and a second irradiation step of irradiating the ultraviolet-curable resin with ultraviolet light from an ultraviolet lamp as a light source in this order. In the configuration illustrated in FIG. 2, the first ultraviolet irradiation reactor 51 and the second ultraviolet irradiation reactor 52 include the ultraviolet LED. The third ultraviolet irradiation reactor 53 and the fourth ultraviolet irradiation reactor 54 include the ultraviolet lamp. That is, ultraviolet irradiation by the first ultraviolet irradiation reactor 51 and the second ultraviolet irradiation reactor 52 corresponds to the first irradiation step, and ultraviolet irradiation by the third ultraviolet irradiation reactor 53 and the fourth ultraviolet irradiation reactor 54 corresponds to the second irradiation step. In the first irradiation step and the second irradiation step, the primary resin layer 22 and the secondary resin layer 24 are formed on the surface of the glass fiber 10. FIG. 2 illustrates the configuration where the two ultraviolet irradiation reactors including the ultraviolet LED and the two ultraviolet irradiation reactors including the ultraviolet lamp are provided. However, the number of the ultraviolet irradiation reactors is not particularly limited. The number of the ultraviolet irradiation reactors including the ultraviolet LED may be, for example, one or more and four or less. The number of the ultraviolet irradiation reactors including the ultraviolet lamp may be, for example, one or more and six or less.

The ultraviolet LED in the first ultraviolet irradiation reactor 51 and the second ultraviolet irradiation reactor 52 is, for example, an LED that emits ultraviolet light having a maximum illuminance in a wavelength range of 350 nm or more and 400 nm or less. The ultraviolet lamp in the third ultraviolet irradiation reactor 53 and the fourth ultraviolet irradiation reactor 54 is, for example, a mercury lamp or a metal halide lamp that emits ultraviolet light having a maximum illuminance in a wavelength range of 200 nm or more and 450 nm or less.

The coating resin film 20 is formed by forming the primary resin layer 22 and the secondary resin layer 24 on the surface of the glass fiber 10 and subsequently forming the colored resin layer 26. Next, the glass fiber 10 is taken up by a take-up machine 70 through guide rollers 61 and 62, and subsequently is further wound up by a winding-up machine 80 through guide rollers 63 and 64. In FIG. 2, the take-up machine 70 includes a combination of rollers and belts.

In the method for manufacturing an optical fiber according to the present embodiment, a surface temperature of the ultraviolet-curable resin at the start of the second irradiation step is 300° C. or lower. Specifically, the start of the second irradiation step refers to the time immediately before introducing the glass fiber 10 into the initial ultraviolet irradiation reactor of the second irradiation step (the third ultraviolet irradiation reactor 53 in the configuration of FIG. 2). In addition, the surface temperature of the ultraviolet-curable resin refers to the surface temperature of the uncured or at least partially cured ultraviolet-curable resin that is applied to the glass fiber 10. In the present embodiment, low-temperature characteristics of the manufactured optical fiber can be improved. Specifically, transmission loss of the optical fiber at a low temperature can be reduced. The lower limit of the surface temperature of the ultraviolet-curable resin at the start of the second irradiation step is not particularly limited and is, for example, 70° C. or higher. The surface temperature of the ultraviolet-curable resin can be measured using, for example, a radiation thermometer. The surface temperature of the ultraviolet-curable resin in the irradiation step can be adjusted by changing the temperature or flow rate of gas flowing through the inside of the ultraviolet irradiation reactor.

The first irradiation step and the second irradiation step may be continuously executed, and another step may be executed between the first irradiation step and the second irradiation step. In the present embodiment, it is preferable that the first irradiation step and the second irradiation step are continuously executed from the viewpoint of productivity. When the first irradiation step and the second irradiation step are continuously executed, it is more preferable that a period of time from the end of the first irradiation step to the start of the second irradiation step is 0.075 seconds or shorter. The lower limit of the period of time from the end of the first irradiation step to the start of the second irradiation step is not particularly limited and is typically 0.010 seconds or longer. Specifically, the period of time from the end of the first irradiation step to the start of the second irradiation step can be calculated by dividing the distance between the final ultraviolet irradiation reactor of the first irradiation step (the second ultraviolet irradiation reactor 52 in the configuration of FIG. 2) and the initial ultraviolet irradiation reactor of the second irradiation step (the third ultraviolet irradiation reactor 53 in the configuration of FIG. 2) by the linear velocity of the glass fiber 10. In order to improve the productivity of the optical fiber, it is preferable to increase the manufacturing rate of the optical fiber. As the manufacturing rate of the optical fiber (also referred to as the rate or linear velocity at which the optical fiber travels in the manufacturing device) increases, the period of time from the end of the first irradiation step to the start of the second irradiation step decreases. When the first irradiation step and the second irradiation step are continuously executed, the productivity of the optical fiber can be improved by setting the period of time from the end of the first irradiation step to the start of the second irradiation step to be 0.075 seconds or shorter.

An oxygen concentration in an outlet of the ultraviolet irradiation reactor used in the first irradiation step (the first ultraviolet irradiation reactor 51 and the second ultraviolet irradiation reactor 52 in the configuration of FIG. 2) is preferably 0.3 vol % or less. The outlet of the ultraviolet irradiation reactor is at a position 130 mm upstream of a boundary between the ultraviolet irradiation reactor and the outside environment. In addition, an oxygen concentration in an outlet of the ultraviolet irradiation reactor used in the second irradiation step (the third ultraviolet irradiation reactor 53 and the fourth ultraviolet irradiation reactor 54 in the configuration of FIG. 2) is preferably 0.6 vol % or less. When oxygen is present in the ultraviolet irradiation reactor, curing of the resin is inhibited by oxygen during the irradiation with ultraviolet light. By reducing the oxygen concentration in the ultraviolet irradiation reactor, the ultraviolet-curable resin can be sufficiently cured, and the external appearance of the manufactured optical fiber can be improved. The oxygen concentration in the outlet of the ultraviolet irradiation reactor can be adjusted, for example, by blowing nitrogen into the ultraviolet irradiation reactor. In both of the first irradiation step and the second irradiation step, the lower limit of the oxygen concentration in the outlet of the ultraviolet irradiation reactor is not particularly limited and is typically 0.01 vol % or more. When a plurality of ultraviolet irradiation reactors are used in the first irradiation step and the second irradiation step, It is preferable that the oxygen concentration in the outlet of at least one ultraviolet irradiation reactor in each of the irradiation steps is in the above-described range, and it is more preferable that the oxygen concentrations in the outlets of all of the ultraviolet irradiation reactors are in the above-described range.

### EXAMPLES

Next, specific examples of the method for manufacturing an optical fiber according to the present disclosure will be further described, but the present invention is not limited to these examples.

### Example 1

A glass fiber obtained by heating and drawing an optical fiber preform was cooled, the cooled glass fiber was applied to an ultraviolet-curable resin, and a layer corresponding to the primary resin layer and a layer corresponding to the secondary resin layer were formed. As an oligomer in the ultraviolet-curable resin corresponding to the primary resin layer, urethane acrylate was used, and the Young's modulus in the primary resin layer was adjusted to be about 1.0 MPa As a photopolymerization initiator in the ultraviolet-curable resin corresponding to the primary resin layer, an acylphosphine oxide-based initiator was used. As an oligomer in the ultraviolet-curable resin corresponding to the secondary resin layer, urethane acrylate was used, and the Young's modulus in the secondary resin layer was adjusted to be about 1000 MPa. As a photopolymerization initiator in the ultraviolet-curable resin corresponding to the secondary resin layer, an acetophenone-based initiator and an acylphosphine oxide-based initiator were used. Next, the glass fiber to which the ultraviolet-curable resin was applied was transported to two ultraviolet irradiation reactors including an ultraviolet LED to be irradiated with ultraviolet light, and was transported to four ultraviolet irradiation reactors including an ultraviolet lamp to be irradiated with ultraviolet light. As a result, the ultraviolet-curable resin was cured. The maximum emission wavelength of the ultraviolet LED was 385 nm. As the ultraviolet lamp, a metal halide lamp was used. Next, the glass fiber was taken up by a take-up machine through guide rollers, and is wound up by a winding-up machine to prepare an optical fiber.

### Examples 2 to 5

Optical fibers were prepared using the same method as that of Example 1, except that the surface temperatures of the ultraviolet-curable resins immediately before the second irradiation step were changed as shown in Table 1.

### Examples 6 to 10

Optical fibers were prepared using the same methods as that of Examples 1 to 5, except that the ultraviolet-curable resins were changed such that the Young's modulus of the primary resin layer was about 0.1 MPa and the Young's modulus of the secondary resin layer was about 2000 MPa.

### Example 11

An optical fiber was prepared using the same method as that of Example 1, except that the ultraviolet-curable resin was changed such that the Young's modulus of the primary resin layer was about 0.3 MPa and the Young's modulus of the secondary resin layer was about 1500 MPa and the surface temperature of the ultraviolet-curable resin immediately before the second irradiation step and the oxygen concentration in the outlet of the ultraviolet irradiation reactor were changed as shown in Table 2.

### Examples 12 to 20

An optical fiber was prepared using the same method as that of Example 11, except that the oxygen concentration in the outlet of the ultraviolet irradiation reactor was changed as shown in Table 2.

### Evaluation

Regarding the optical fibers obtained through the above-described steps, the following items were evaluated.

### <Low-Temperature Characteristics>

A tension of 1.5 kg was applied to the optical fiber for screening, transmission loss (wavelength: 1.33 μm) of the optical fiber was measured in environments of 25° C. and −40° C. to evaluated an increase in transmission loss at the low temperature. A case where the increase in transmission loss at the low temperature was 0.03 dB/km or less was evaluated as A, and a case where the increase in transmission loss at the low temperature was more than 0.03 dB/km was evaluated as C.

### <External Appearance>

When the optical fiber wound around a bobbin was observed, a case where glittered light was not observed on the optical fiber surface was evaluated as A, and a case where the surface looked glittered was evaluated as C. When the surface of the optical fiber looked glittered, surface characteristics were considered to be defective.

The surface temperature of the ultraviolet-curable resin immediately before the second irradiation step, the oxygen concentration in the outlet of each of the ultraviolet irradiation reactors in the first irradiation step and the second irradiation step, the Young's modulus of the primary resin layer, the Young's modulus of the secondary resin layer, and the evaluation results of the low-temperature characteristics and the external appearance are shown in Tables 1 and 2.

TABLE 1

| | Exam- | Exam- | Exam- | Exam- | Exam- | Exam- | Exam- | Exam- | Exam- | Exam- |
|---|---|---|---|---|---|---|---|---|---|---|
| | ple 1 | ple 2 | ple 3 | ple 4 | ple 5 | ple 6 | ple 7 | ple 8 | ple 9 | ple 10 |
| Surface | 70 | 190 | 300 | 315 | 350 | 75 | 170 | 290 | 320 | 380 |
| Temperature | | | | | | | | | | |
| Immediately | | | | | | | | | | |
| before | | | | | | | | | | |
| Second | | | | | | | | | | |
| Irradiation | | | | | | | | | | |
| Step [° C.] | | | | | | | | | | |
| Oxygen | 0.18 | 0.20 | 0.19 | 0.19 | 0.19 | 0.18 | 0.21 | 0.19 | 0.19 | 0.20 |
| Concentration | | | | | | | | | | |
| in Outlet | | | | | | | | | | |
| in First | | | | | | | | | | |
| Irradiation | | | | | | | | | | |
| Step [vol %] | | | | | | | | | | |
| Oxygen | 0.28 | 0.31 | 0.40 | 0.37 | 0.30 | 0.29 | 0.31 | 0.37 | 0.32 | 0.32 |
| Concentration | | | | | | | | | | |
| in Outlet | | | | | | | | | | |
| in Second | | | | | | | | | | |
| Irradiation | | | | | | | | | | |
| Step [vol %] | | | | | | | | | | |
| Primary | 1.01 | 0.94 | 1.02 | 1.01 | 1.05 | 0.08 | 0.10 | 0.14 | 0.17 | 0.10 |
| Young's | | | | | | | | | | |
| Modulus | | | | | | | | | | |
| [MPa] | | | | | | | | | | |
| Secondary | 976 | 1005 | 1055 | 1081 | 1050 | 1891 | 1990 | 1880 | 1950 | 2000 |
| Young's | | | | | | | | | | |
| Modulus | | | | | | | | | | |
| [MPa] | | | | | | | | | | |
| Low- | A | A | A | C | C | A | A | A | C | C |
| Temperature | | | | | | | | | | |
| Characteristics | | | | | | | | | | |
| External | A | A | A | A | A | A | A | A | A | A |
| Appearance | | | | | | | | | | |

TABLE 2

| | Exam- | Exam- | Exam- | Exam- | Exam- | Exam- | Exam- | Exam- | Exam- | Exam- |
|---|---|---|---|---|---|---|---|---|---|---|
| | ple 11 | ple 12 | ple 13 | ple 14 | ple 15 | ple 16 | ple 17 | ple 18 | ple 19 | ple 20 |
| Surface | 100 | 100 | 100 | 100 | 100 | 100 | 100 | 100 | 100 | 100 |
| Temperature | | | | | | | | | | |
| Immediately | | | | | | | | | | |
| before | | | | | | | | | | |
| Second | | | | | | | | | | |
| Irradiation | | | | | | | | | | |
| Step [° C.] | | | | | | | | | | |
| Oxygen | 0.10 | 0.20 | 0.30 | 0.40 | 0.70 | 0.18 | 0.21 | 0.19 | 0.19 | 0.20 |
| Concentration | | | | | | | | | | |
| in Outlet | | | | | | | | | | |
| in First | | | | | | | | | | |
| Irradiation | | | | | | | | | | |
| Step [vol %] | | | | | | | | | | |
| Oxygen | 0.28 | 0.31 | 0.37 | 0.32 | 0.32 | 0.10 | 0.35 | 0.51 | 0.60 | 0.72 |
| Concentration | | | | | | | | | | |
| in Outlet | | | | | | | | | | |
| in Second | | | | | | | | | | |
| Irradiation | | | | | | | | | | |
| Step [vol %] | | | | | | | | | | |
| Primary | 0.30 | 0.30 | 0.30 | 0.30 | 0.30 | 0.30 | 0.30 | 0.30 | 0.30 | 0.30 |
| Young's | | | | | | | | | | |
| Modulus | | | | | | | | | | |
| [MPa] | | | | | | | | | | |
| Secondary | 1500 | 1500 | 1500 | 1500 | 1500 | 1500 | 1500 | 1500 | 1500 | 1500 |
| Young's | | | | | | | | | | |
| Modulus | | | | | | | | | | |
| [MPa] | | | | | | | | | | |
| Low- | A | A | A | A | A | A | A | A | A | A |
| Temperature | | | | | | | | | | |
| Characteristics | | | | | | | | | | |
| External | A | A | A | C | C | A | A | A | C | C |
| Appearance | | | | | | | | | | |

According to the above-described results, when the surface temperature of the ultraviolet-curable resin immediately before the second irradiation step is 300° C. or lower, the low-temperature characteristics of the optical fiber are excellent. In addition, when the oxygen concentration in the outlet of the ultraviolet irradiation reactor in the first irradiation step is 0.3 vol % or less and the oxygen concentration in the outlet of the ultraviolet irradiation reactor in the second irradiation step is 0.6 vol % or less, the external appearance of the optical fiber is excellent.

### REFERENCE SIGNS LIST

1A: optical fiber
10: glass fiber
12: core
14: cladding
20: coating resin film
22: primary resin layer
24: secondary resin layer
26: colored resin layer
30: cooling device
40: application device
51: first ultraviolet irradiation reactor
52: second ultraviolet irradiation reactor
53: third ultraviolet irradiation reactor
54: fourth ultraviolet irradiation reactor
61, 62, 63, 64: guide roller
70: take-up machine
80: winding-up machine
100: heating furnace
101: furnace tube
102: heater
G: optical fiber preform

What is claimed is:

1. A method for manufacturing an optical fiber from a glass fiber obtained by heating and drawing an optical fiber preform, the method comprising:
an application step of applying an ultraviolet-curable resin to the glass fiber; and
a curing step of irradiating the ultraviolet-curable resin with ultraviolet light to cure the ultraviolet-curable resin,
wherein the curing step includes: a first irradiation step of irradiating the ultraviolet-curable resin with ultraviolet light from an ultraviolet LED as a light source; and a second irradiation step of irradiating the ultraviolet-curable resin with ultraviolet light from an ultraviolet lamp as a light source in this order, and
a surface temperature of the ultraviolet-curable resin at start of the second irradiation step is 300° C. or lower.

2. The method for manufacturing an optical fiber according to claim 1,
wherein the second irradiation step is executed continuously after the first irradiation step.

3. The method for manufacturing an optical fiber according to claim 2,
wherein a period of time from end of the first irradiation step to the start of the second irradiation step is 0.075 seconds or shorter.

4. The method for manufacturing an optical fiber according to claim 1,
wherein an oxygen concentration in an outlet of an ultraviolet irradiation reactor used in the first irradiation step is 0.3 vol % or less, and an oxygen concentration in an outlet of an ultraviolet irradiation reactor used in the second irradiation step is 0.6 vol % or less.
